(19) United States
(12) Patent Application Publication
(10) Pub. No.: US 2015/0196037 A1
(43) Pub. Date: Jul. 16, 2015

(54) FOOD ASSEMBLY AND CONTAINER THEREFOR

(71) Applicant: Give & Go Prepared Foods Corp., Toronto (CA)

(72) Inventors: Joel Barry Flatt, Toronto (CA); Todd Cameron Parsons, Carlisle (CA)

(21) Appl. No.: 14/596,445

(22) Filed: Jan. 14, 2015

Related U.S. Application Data
(60) Provisional application No. 61/927,300, filed on Jan. 14, 2014.

(51) Int. Cl. A21D 13/08; B65D 65/02; B65D 43/02; A21D 13/00; B65D 25/10

(52) U.S. Cl. CPC A21D 13/08; A21D 13/0009; A21D 13/0067; B65D 25/108; B65D 43/02; B65D 65/02

(57) ABSTRACT

A food assembly includes a first layer, which may be formed of cake, and a second layer, which may be formed of icing. The first layer may include at least four food elements. The food elements may be shaped so that tops of the food elements are contiguous and define a top surface of the first layer. The second layer adjoins the top surface. Upon pulling a selected one of the food elements away from the remainder of the first layer, a portion of the second layer is separated from the remainder of the second layer. The food assembly may be combined with a container having a base and at least four pockets, and each of the food elements of the food assembly may be nested in a respective one of the pockets.

### CROSS REFERENCE TO RELATED APPLICATION

This application claims priority to U.S. Provisional Application No. 61/927,300 filed on Jan. 14, 2014, the entire contents of which are hereby incorporated herein by reference.

### FIELD

The present disclosure relates to baked goods and containers for storing baked goods.

### INTRODUCTION

The following paragraphs are intended to introduce the reader to the more detailed description that follows and not to define or limit the claimed subject matter.

According to an aspect of the present disclosure, a food assembly includes first and second layers. The first layer may include at least four food elements. Each of the food elements may include a bottom, a top spaced apart from the bottom, and an outer side surface extending between the bottom and the top. The top and the outer side surface may meet at at least one top side edge. For each of the food elements, portions of the top side edge and a corresponding top side edge of an adjacent one of the food elements may be complementary in shape so that the tops are contiguous and define a top surface of the first layer. The second layer adjoins the top surface of the first layer, and includes a lower surface that bears against the tops of the food elements, and an upper surface spaced apart from the lower surface. Upon pulling a selected one of the food elements away from the remainder of the first layer, a portion of the second layer associated with the selected one of the food elements is separated from the remainder of the second layer.

For each of the food elements, the top may be shaped generally as a square. A sum of the surface areas of the tops of the food elements may form at least 90% of a perimeter surface area of the top surface of the first layer. For each of the food elements, the bottom may be shaped generally as a circle. For each of the food elements, a width dimension of the top may be larger than a diameter dimension of the bottoms so that the outer side surface flares outwardly from the bottom to the top. For each of the food elements, the outer side surface may extend outwardly from the bottom to the top at an angle of between 10 and 30 degrees relative to vertical.

Each of the food elements may be formed of cake, and the second layer may be formed of icing.

The food assembly may be combined with a container including a base having a base peripheral edge, and at least four pockets arranged within the base peripheral edge. Each of the food elements of the food assembly may be nested in a respective one of the pockets.

The container may include a lid having a lid peripheral edge and an upper lid surface. In a closed position, the lid peripheral edge may be engaged with the base peripheral edge of the base, and the upper lid surface covers the food assembly. In an open position, the lid peripheral edge and the base peripheral edge may be disengaged permitting access to the food assembly.

Each of the pockets may include an inner surface supporting the outer side surface of the respective one of the elements. The inner surface may terminate at an upper rim. The second layer of the food assembly may be spaced apart from the upper rim. For each of the food elements, a disposable wrapper may cover the outer side surface between the upper rim and the second layer.

According to an aspect of the present disclosure, a food assembly includes first and second layers. The first layer may include at least four food elements. Each of the food elements may include a bottom, a top spaced apart from the bottom, a central axis extending between the bottom and the top, and an outer side surface extending between the bottom and the top. The top and the outer side surface may meet at at least one top side edge. The food elements may be arranged so that the tops are contiguous to define a top surface of the first layer. The second layer adjoins the top surface of the first layer, and includes a lower surface that bears against the tops of the food elements, and an upper surface spaced apart from the lower surface. For each of the food elements, the top side edge may include at least one complementary segment that is adjacent to the complementary segment of a corresponding top side edge of an adjacent one of the food elements. For each of the food elements, the top side edge may include at least one non-complementary segment that is adjacent to a respective opening formed between the tops of the food elements. For each of the food elements, the non-complementary segment may be spaced further away from the central axis than the complementary segment.

For each of the food elements, the complementary segment may be generally linear. For each of the food elements, a length of the complementary segment may extend a majority of a width dimension of the food element. For each of the food elements, the complementary segment and the complementary segment of the corresponding top side edge of the adjacent one of the food elements may be of equivalent length. For each of the food elements, a distance between the complementary segment and the complementary segment of the corresponding top side edge of the adjacent one of the food elements may be uniform along a majority of their lengths. For each of the food elements, a disposable wrapper may cover the outer side surface, and the complementary segment may approximate an external profile of the disposable wrapper at the portion of the top side edge.

According to an aspect of the present disclosure, a food assembly includes first and second layers. The first layer may include a plurality of food elements. Each of the food elements may include a bottom that is shaped generally as a circle, a top that is shaped generally as a square, and an outer side surface extending outwardly between the bottom and the top. The food elements may be arranged in an array so that the tops are contiguous and define a top surface of the first layer. The second layer adjoins the top surface of the first layer. Upon pulling a selected one of the food elements away from the remainder of the first layer, a portion of the second layer associated with the selected one of the food elements may be separated from the remainder of the second layer.

### BRIEF DESCRIPTION OF THE DRAWINGS

The drawings included herewith are for illustrating various examples of apparatuses and methods of the present disclosure and are not intended to limit the scope of what is taught in any way. In the drawings:

FIG. 1 is a perspective view of a first layer including food elements;

FIG. 2 is a perspective view of a food assembly including the first layer and a second layer adjoining the first layer;

FIG. 3 is a perspective view of one of the food elements being pulled away from the remainder of the first layer, and a portion of the second layer is separated from the remainder of the second layer;

FIG. 4 is a top view of one of the food elements; FIG. 5 is a sectional view along line 5-5 in FIG. 4; FIG. 6 is a sectional view along line 6-6 in FIG. 4; FIG. 7 is a top view of the first layer; FIG. 8 is a detailed, schematic view of a portion of FIG. 7; FIG. 9 is a detailed, top view of a portion of FIG. 7; FIG. 10 is an exploded, perspective view of a container;

FIG. 11 is a perspective view of the food assembly housed in the container; and

FIG. 12 is an end view of two of the containers in a stacked arrangement.

### DETAILED DESCRIPTION

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

Referring to FIG. 1, a first layer 20 includes food elements 22. Each of the food elements 22 includes a bottom 24, a top 26, and an outer side surface 28 extending between the bottom 24 and the top 26. In some examples, each of the food elements 22 may be formed of cake. In some examples, each of the food elements 22 may be formed of muffin or other bread-like food.

In the example illustrated, the bottom 24 and the outer side surface 28 of each of the food elements 22 is surrounded by a disposable wrapper 92, which is shown to have corrugated sidewalls. In the example illustrated, the disposable wrappers 92 cover the entirety of the outer side surfaces 28 of the food elements 22, and each terminates approximately at a top side edge where the outer side surface 28 and the top 26 meet. In some examples, the food elements 22 may be provided without a disposable wrapper.

As illustrated, the tops 26 of the food elements 22 may be generally flat and at the same elevation, such that the tops 26 are approximately coplanar. In some examples, the tops 26 are not exactly planar and, e.g., may be slightly domed in shape. The tops 26 of the food elements 22 define a top surface 30 that is contiguous across the first layer 20.

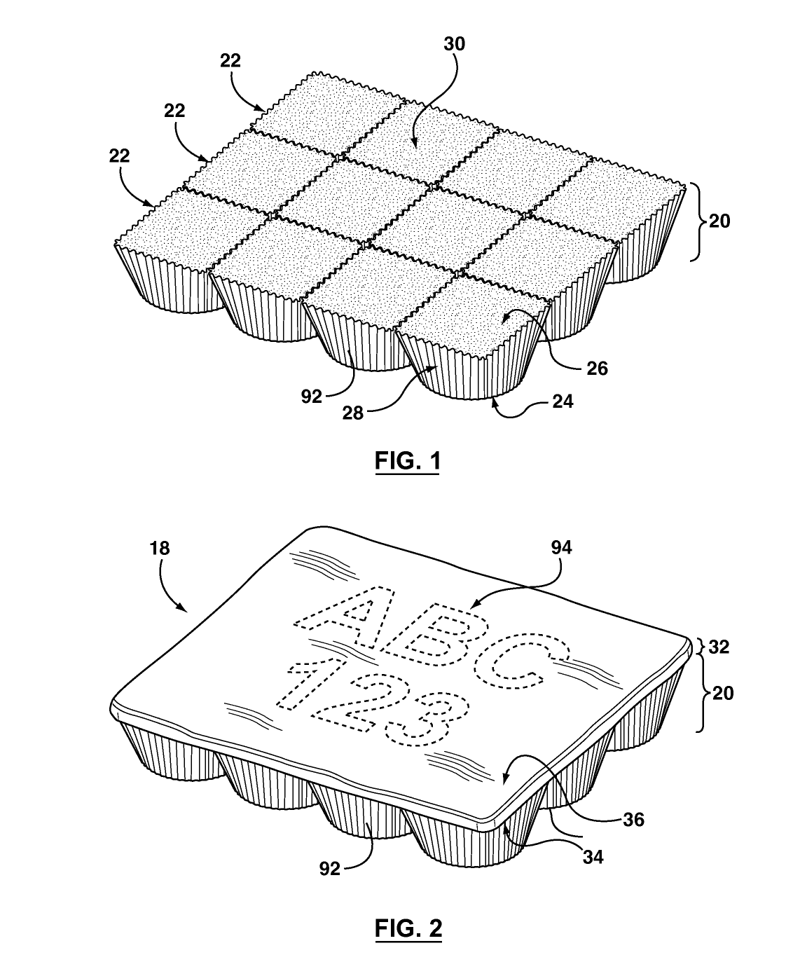

Referring to FIG. 2, a food assembly 18 includes a second layer 32 adjoining the top surface 30 (FIG. 1) of the first layer 20. The second layer 32 includes a lower surface 34 that bears against the tops 26 of the food elements 22 (FIG. 1) and an upper surface 36. In some examples, the second layer 32 may be formed of a single layer of icing. In some examples, the second layer 32 may be formed of one or more layers of icing applied overtop a base layer of icing that has been applied to the top surface 30 of the first layer 20 (FIG. 1). In some examples, the second layer 32 may be formed of single or multiple layers of another frangible, edible material.

In the example illustrated, the upper surface 36 includes a decorated section 94. The decorated section 94 is shown to extend on the upper surface 36 across portions of the second layer 32 associated with several of the food elements 22. The second layer 32 may vary in thickness. In some examples, the second layer 32 may have a thickness of between 0.25 and 0.375 inches. The second layer 32 may be thicker in regions of the decorated section 94, and in these regions have a thickness of between, e.g., 0.375 and 0.5 inches.

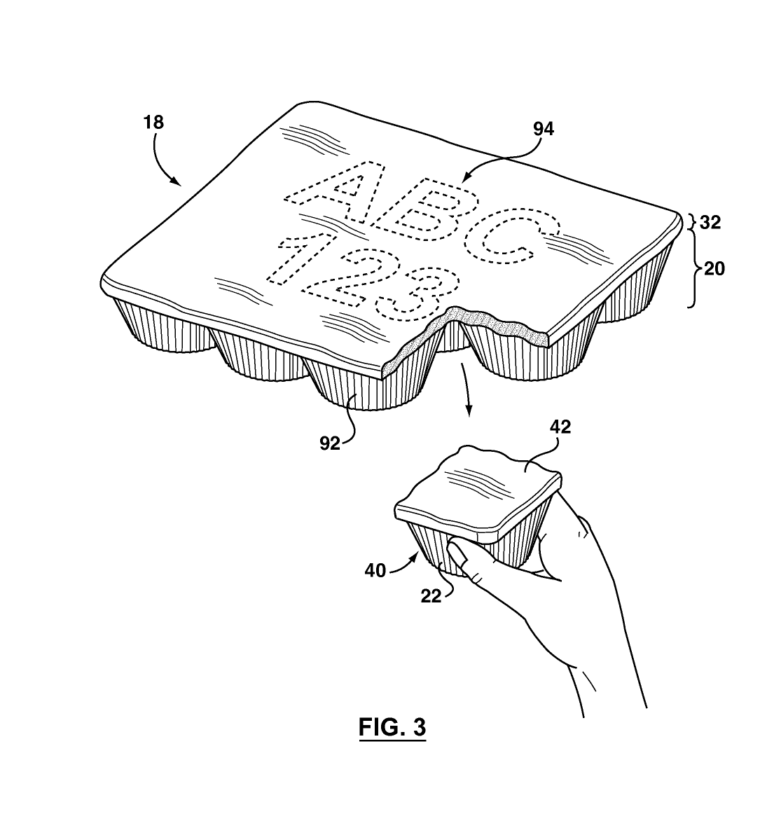

Referring to FIG. 3, a selected one 40 of the food elements 22 is shown being pulled away from the remainder of the first layer 20. A portion 42 of the second layer 32 associated with the selected one 40 of the food elements 22 is shown separated from the remainder of the second layer 32.

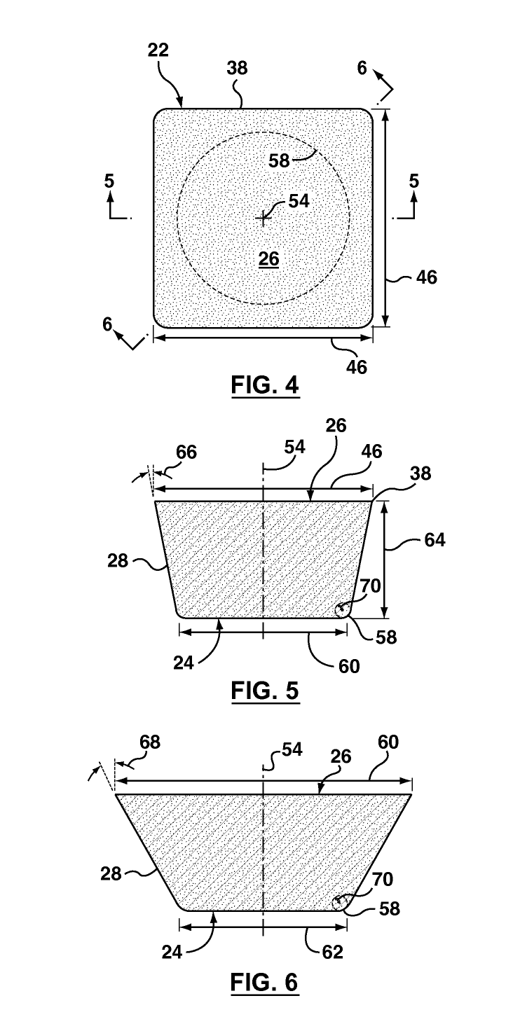

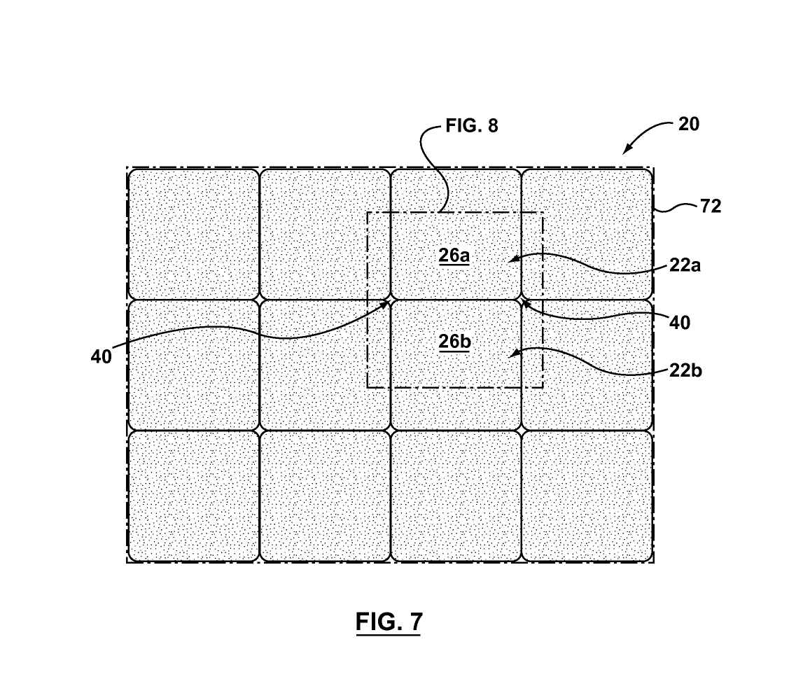

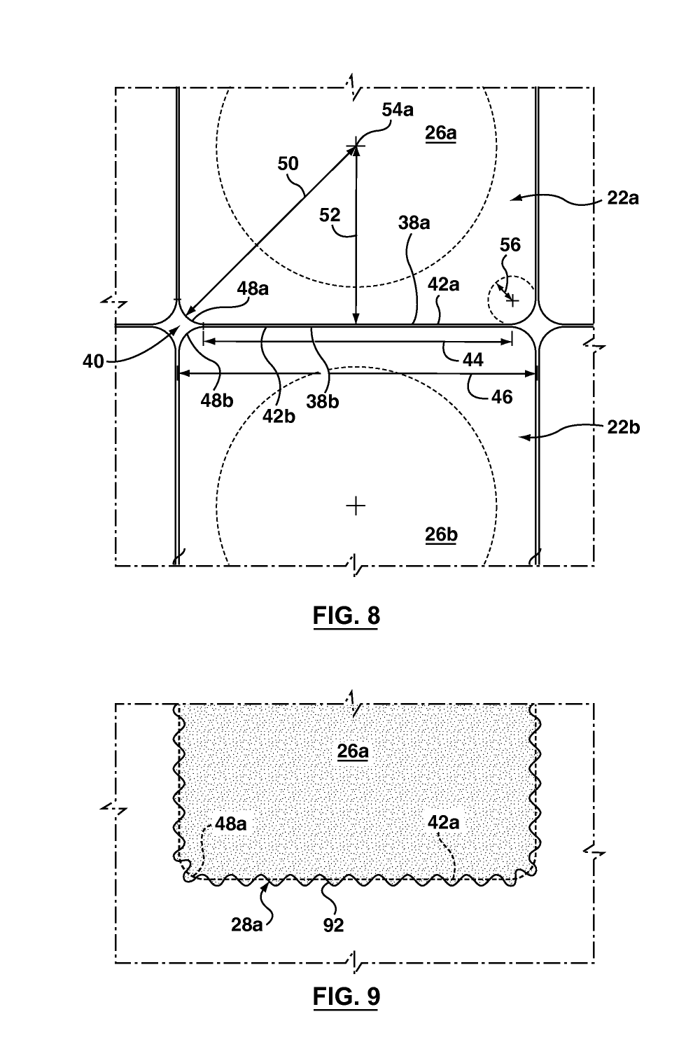

For clarity of illustration, FIGS. 4 to 8 show the food elements 22 without a disposable wrapper 92 (FIG. 1).

Referring to FIGS. 4 and 5, the top 26 and the outer side surface 28 of the food element 22 are shown to meet at top side edges 38.

Referring to FIGS. 7 and 8, the top side edge 38a of one of the food elements 22a and a corresponding top side edge 38b of an adjacent one of the food elements 22b may be complementary in shape. Accordingly, the top side edges 38a, 38b may fit together and may minimize the size of openings 40 that are formed between the tops 26a, 26b of the food elements 22a, 22b. By minimizing the size of the openings 40, the first layer 20 may provide good support for the second layer 32 when assembled as the food assembly 18 (FIG. 2), across almost the entirety of the first layer 20. In some examples, this may permit the use of a relatively thin second layer 32.

Referring to FIG. 8, the top side edge 38a is shown to include a complementary segment 42a that is adjacent to a complementary segment 42b of the corresponding top side edge 38b of the food elements 22b. In the example illustrated, the complementary segments 42a, 42b are linear, and each of the food elements 22 is shown to have four of the complementary segments, so the top 26 is shaped roughly as a square (FIG. 4). In other examples, food elements with tops having a different shape, e.g., rectangles, triangles, diamonds, and other geometric shapes, including shapes with non-linear sides, may be possible, so the tops fit together, and the size of openings formed between the tops is small relative to the dimensions of the tops.

In the example illustrated, the complementary segments 42a, 42b are uniformly spaced apart from one another, and both have a length 44 that is equivalent and extends a majority of a width dimension 46 of the food elements 22a, 22b. Although FIG. 8 illustrates the complementary segments 42a, 42b to be spaced apart from one another, with a distance between them being uniform, they may instead touch along a majority of their lengths.

The top side edges 38a, 38b may also include non-complementary segments 48a, 48b, respectively. In the example illustrated, the non-complementary segments 48a, 48b are adjacent to the respective opening 40 formed between the tops 26a, 26b of the food elements 22a, 22b. As illustrated, distance 50 is substantially greater than distance 52, so the non-complementary segment 48a is spaced further away from a central axis 54a of the food element 22a than the complementary segment 42a. With this relationship, the size of the openings 40 may be minimized. Referring to FIGS. 4 to 6, the central axis 54 extends between the bottom 24 and the top 26. The central axis 54 may extend vertically through a centroid of each of the food elements 22.

Referring to FIG. 9, the food element 22a is shown with the disposable wrapper 92. In the example illustrated, the disposable wrapper 92 includes corrugated sidewalls that cover the outer side surface 28a of the food element 22a. The corrugated sidewalls are shown to have an undulating, wave format with crests and troughs. The complementary segment 42a and the non-complementary segment 48a are shown to fall midway between the crests and the troughs. Accordingly, in some examples, while the complementary segment 42a is shown to be linear, it is an approximation of the external profile of the disposable wrapper 92 at the portion of the top side edge formed by the top 26a and the outer side surface 28a, and does not represent its shaping exactly.

Referring to FIG. 8, the non-complementary segments are shown to have a radius of curvature 56. The radius of curvature 56 may be desirable and/or necessary due to limitations in the manufacture of a suitable baking pan (not shown) used to bake the food elements 22. In some examples, the radius of curvature 56 may be about 0.1180 inches. The radius of curvature 56 may be relatively small in comparison to the width dimension 46 of the food element 22. In some examples, a ratio between the radius of curvature 56 and the width dimension 46 may be less than about 0.097, or less than about 0.072, or less than about 0.059. In other examples, the non-complementary segments may not be arcuate.

Referring to FIGS. 4 to 6, the bottom 24 and the outer side surface 28 are shown to meet at a bottom side edge 58. In the example illustrated, the bottom side edge 58 is curvilinear, so the bottom 24 is shaped roughly as a circle. With this shape, the food element 22 may have an appearance that is similar to the bottom of a typical cupcake or muffin, despite the fact that, in the example illustrated, the top 26 is shaped roughly as a square (FIG. 4).

In the example illustrated, both the width dimension 46 and a diagonal dimension 60 are larger than a diameter dimension 62 of the bottom 24. Accordingly, the outer side surface 28 flares outwardly from the bottom 24 to the top 26, about the entirety of the food element 22. Parallel to the central axis 54, the food element 22 has a height dimension 64 between the bottom 24 and the top 26. In the example illustrated, the outer side surface 28 extends outwardly from the bottom 24 to the top 26 at first and second angles 66, 68 relative to vertical. In some examples, each of the first and second angles 66, 68 may range between 10 and 30 degrees.

Referring to FIGS. 5 and 6, a radius of curvature 70 is shown between the bottom 24 and the outer side surface 28. The radius of curvature 56 may be desirable and/or necessary due to limitations in the manufacture of a suitable baking pan (not shown) used to bake the food elements 22. In some examples, the radius of curvature 70 may be about 0.125 inches.

The food elements 22 may be made of varying sizes. Table 1 below provides exemplary dimensions (in inches) that correspond to the food element 22 illustrated in FIGS. 4 to 6. The exemplary dimensions are intended to be illustrative and non-limiting.

TABLE 1

| | Example | | |
|---|---|---|---|
| Dimension | A | B | C |
| Width 46 | 1.9293 | 2.6250 | 3.1678 |
| Diameter 62 | 1.5000 | 2.0000 | 2.5000 |
| Height 64 | 1.1043 | 1.4030 | 1.7178 |

Referring to FIG. 7, the food elements 22a, 22b are shown arranged in an array to form the first layer 20. While twelve of the food elements are shown in a 3×4 arrangement, the exact number and arrangement of the food elements may be varied.

In the example illustrated, the size of the openings 40 between adjacent food elements 22 is small relative to the dimensions of the tops of the food elements 22. By minimizing the size of the openings 40, as mentioned herein, the first layer 20 may provide good support for the second layer 32 when assembled as the food assembly 18 (FIG. 2). In some examples, the sum of the surface areas of the tops 26 of the food elements 22 may form at least 90% of the surface area of an outer perimeter 72 of the first layer 20. In some examples, the sum of the surface areas of the tops 26 of the food elements 22 may form at least 95% of the surface area of the perimeter 72. In some examples, the sum of the surface areas of the tops 26 of the food elements 22 may form at least 99% of the surface area of the perimeter 72. In some examples, the sum of the surface areas of the tops 26 of the food elements 22 may form at least 99.5% of the surface area of the perimeter 72.

Referring to FIG. 10, a container 74 includes a base 76 having a base peripheral edge 78 and pockets 80. The container 74 also includes a lid 82 having a lid peripheral edge 84 and an upper lid surface 86. Each of the pockets 80 of the base 76 includes an inner surface 88 for supporting the outer side surface 28 of a respective one of the food elements 22 (FIG. 1). In the example illustrated, the inner surfaces 88 terminate at an upper rim 90.

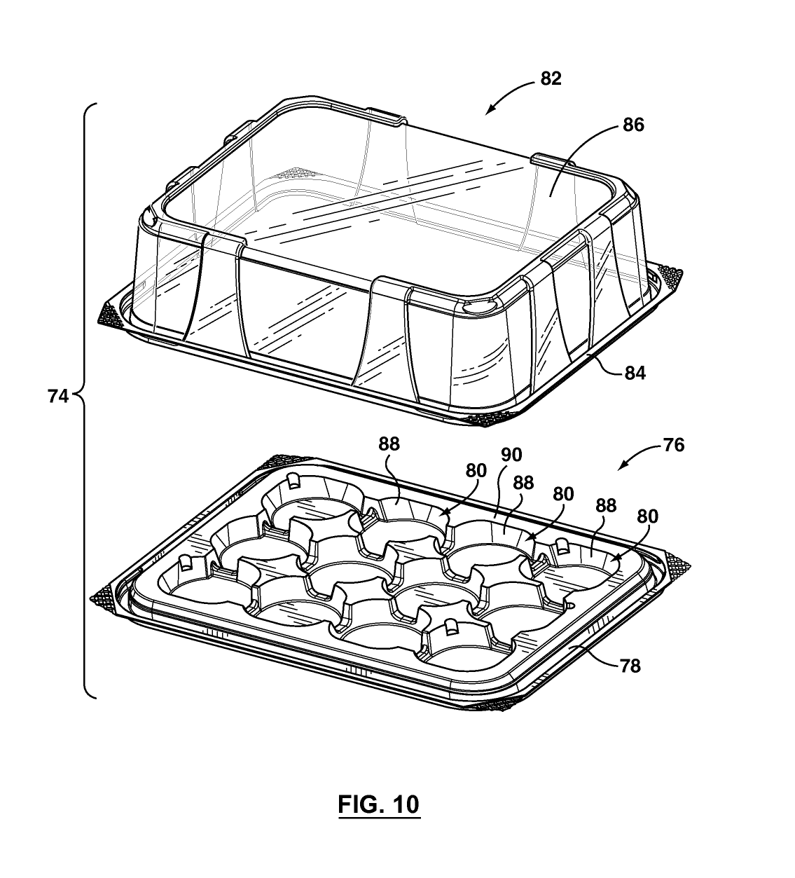

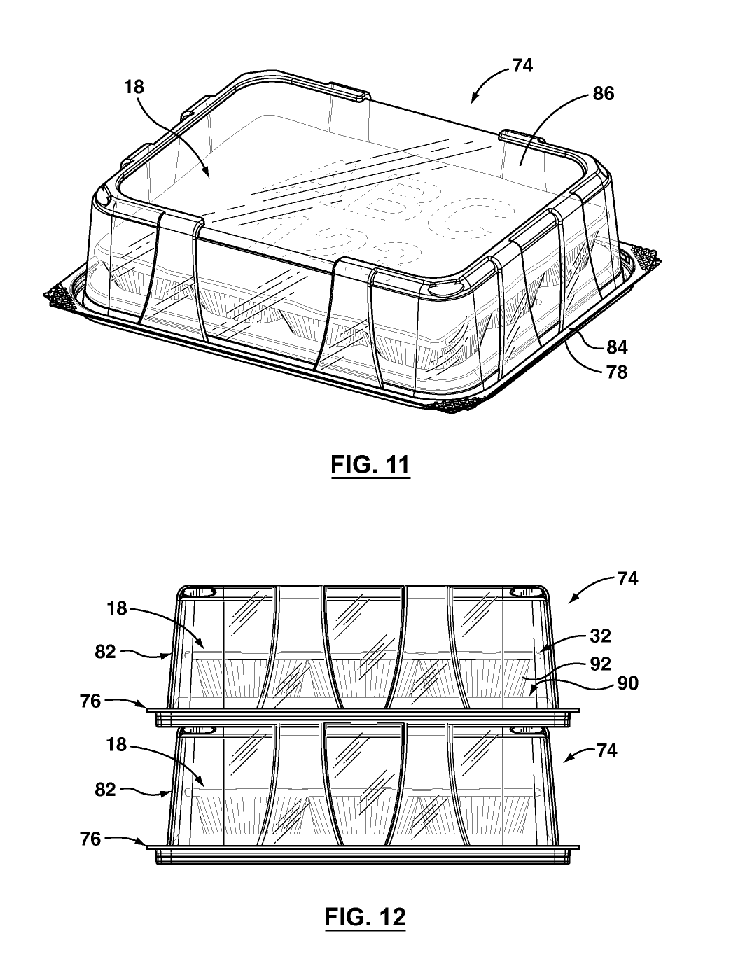

Referring to FIG. 11, the food assembly 18 is housed in the container 74, with each of the food elements of the food assembly 18 nested in a respective one of the pockets. In a closed position, as illustrated, the lid peripheral edge 84 is engaged with the base peripheral edge 78, and the upper lid surface 86 covers the food assembly 18.

The base 76 and the lid 82 may be designed to be relatively rigid and, in the closed position, the container 74 may prevent or reduce torqueing of the food assembly 18, and therefore prevent or reduce the risk of damage during transport. In an open position (FIG. 10), the lid peripheral edge 84 and the base peripheral edge 78 are disengaged permitting access to the food assembly 18.

Referring to FIG. 12, the top of the lid 82 of one container 74 may be received by the bottom of the base 76 of another container 74, permitting a stacked arrangement. As illustrated, the pockets 80 of the base 76 may be relatively shallow, with the second layer 32 of the food assembly 18 spaced apart from the upper rim 90. This may permit selection of one of the food elements, by grabbing the disposable wrapper 92 covering the outer side surface between the upper rim 90 and the second layer 32, while the food assembly 18 is held by the base 76.

While the above description provides examples of one or more apparatuses or methods, it will be appreciated that other apparatuses or methods may be within the scope of the accompanying claims.

We claim:

1. A food assembly, comprising:
a first layer comprising at least four food elements, each of the food elements comprising a bottom, a top spaced apart from the bottom, and an outer side surface extending between the bottom and the top, the top and the outer side surface meeting at at least one top side edge, wherein, for each of the food elements, portions of the top side edge and a corresponding top side edge of an adjacent one of the food elements are complementary in shape so that the tops are contiguous and define a top surface of the first layer; and
a second layer adjoining the top surface of the first layer, the second layer comprising a lower surface that bears against the tops of the food elements, and an upper surface spaced apart from the lower surface, wherein, upon pulling a selected one of the food elements away from the remainder of the first layer, a portion of the second layer associated with the selected one of the food elements is separated from the remainder of the second layer.

2. The food assembly of claim 1, wherein, for each of the food elements, the top is shaped generally as a square.

3. The food assembly of claim 2, wherein a sum of the surface areas of the tops of the food elements forms at least 90% of a perimeter surface area of the top surface of the first layer.

4. The food assembly of claim 3, wherein, for each of the food elements, the bottom is shaped generally as a circle.

5. The food assembly of claim 4, wherein, for each of the food elements, a width dimension of the top is larger than a diameter dimension of the bottoms so that the outer side surface flares outwardly from the bottom to the top.

6. The food assembly of claim 5, wherein, for each of the food elements, the outer side surface extends outwardly from the bottom to the top at an angle of between 10 and 30 degrees relative to vertical.

7. The food assembly of claim 1, wherein each of the food elements is formed of cake, and the second layer is formed of icing.

8. In combination:
the food assembly of claim 1; and
a container comprising a base having a base peripheral edge, and at least four pockets arranged within the base peripheral edge, wherein each of the food elements of the food assembly is nested in a respective one of the pockets.

9. The combination of claim 8, wherein the container comprises a lid having a lid peripheral edge and an upper lid surface, and, in a closed position, the lid peripheral edge is engaged with the base peripheral edge of the base, and the upper lid surface covers the food assembly.

10. The combination of claim 9, wherein, in an open position, the lid peripheral edge and the base peripheral edge are disengaged permitting access to the food assembly.

11. The combination of claim 8, wherein each of the pockets comprises an inner surface supporting the outer side surface of the respective one of the elements, the inner surface terminating at an upper rim.

12. The combination of claim 11, wherein the second layer of the food assembly is spaced apart from the upper rim.

13. The combination of claim 12, wherein, for each of the food elements, a disposable wrapper covers the outer side surface between the upper rim and the second layer.

14. A food assembly, comprising:
a first layer comprising at least four food elements, each of the food elements comprising a bottom, a top spaced apart from the bottom, a central axis extending between the bottom and the top, and an outer side surface extending between the bottom and the top, the top and the outer side surface meeting at at least one top side edge, the food elements arranged so that the tops are contiguous to define a top surface of the first layer; and
a second layer adjoining the top surface of the first layer, the second layer comprising a lower surface that bears against the tops of the food elements, and an upper surface spaced apart from the lower surface,
wherein, for each of the food elements, the top side edge comprises at least one complementary segment that is adjacent to the complementary segment of a corresponding top side edge of an adjacent one of the food elements,
wherein, for each of the food elements, the top side edge comprises at least one non-complementary segment that is adjacent to a respective opening formed between the tops of the food elements, and wherein, for each of the food elements, the non-complementary segment is spaced further away from the central axis than the complementary segment.

15. The food assembly of claim 14, wherein, for each of the food elements, the complementary segment is generally linear.

16. The food assembly of claim 15, wherein, for each of the food elements, a length of the complementary segment extends a majority of a width dimension of the food element.

17. The food assembly of claim 16, wherein, for each of the food elements, the complementary segment and the complementary segment of the corresponding top side edge of the adjacent one of the food elements are of equivalent length.

18. The food assembly of claim 17, wherein, for each of the food elements, a distance between the complementary segment and the complementary segment of the corresponding top side edge of the adjacent one of the food elements is uniform along a majority of their lengths.

19. The food assembly of claim 14, wherein, for each of the food elements, a disposable wrapper covers the outer side surface, and the complementary segment approximates an external profile of the disposable wrapper at the portion of the top side edge.

20. A food assembly, comprising:
a first layer comprising a plurality of food elements, each of the food elements comprising a bottom that is shaped generally as a circle, a top that is shaped generally as a square, and an outer side surface extending outwardly between the bottom and the top, wherein the food elements are arranged in an array so that the tops are contiguous and define a top surface of the first layer; and
a second layer adjoining the top surface of the first layer, wherein, upon pulling a selected one of the food elements away from the remainder of the first layer, a portion of the second layer associated with the selected one of the food elements is separated from the remainder of the second layer.
